(19) United States
(12) Patent Application Publication
(10) Pub. No.: US 2014/0306879 A1
(43) Pub. Date: Oct. 16, 2014

(54) 3D DISPLAY DEVICE

(71) Applicant: Japan Display Inc., Tokyo (JP)

(72) Inventors: Shinichiro OKA, Tokyo (JP); Shinichi KOMURA, Tokyo (JP); Tomohiko NAGANUMA, Tokyo (JP)

(73) Assignee: Japan Display Inc., Tokyo (JP)

(21) Appl. No.: 14/249,475

(22) Filed: Apr. 10, 2014

(30) Foreign Application Priority Data
Apr. 12, 2013 (JP) 2013-084083

(51) Int. Cl. G06F 3/01; G09G 3/36; H04N 13/04

(52) U.S. Cl. CPC G06F 3/013; H04N 13/0484; G09G 3/36
USPC 345/156

(57) ABSTRACT

Two-parallax autostereoscopic display device using eye tracking has a problem in which the brightness is varied depending on the direction of viewing angle. A 3D display device is provided with a detection part for recognizing a position of eyes from an image taken by a camera; a separation mechanism which enables a 3D image to be regenerated at the optimum position for eyes based on information on the position of eyes detected by the detection part; a display device for displaying a plurality of different parallax images at the same time; a backlight attached to the display device; and a backlight control part for controlling the backlight, wherein the backlight control part determines brightness of the backlight in accordance with the position of eyes determined by the detection part.

### CLAIM OF PRIORITY

The present application claims priority from Japanese patent application JP2013-084083 filed on Apr. 12, 2013, the content of which is hereby incorporated by reference into this application.

### BACKGROUND

The present disclosure relates to a 3D display device which is applicable to, for example, an autostereoscopic display device using eye tracking.

An autostereoscopic display has been applied to game machines, cellular phones, televisions and so on. In the case of a two-parallax type autostereoscopic display, the position where an image can be recognized as being 3D is only at an angle of a few degrees from the front of a panel, and thus viewing position is limited. As a method for improving this, a multi-parallax system is generally employed. In the case of multi-parallax system, it is necessary to sacrifice the resolution of a display panel in order to increase the position where an image can be recognized as being 3D.

On the other hand, in the two-parallax autostereoscopic display using eye tracking, moving viewpoints increases the position where an image can be recognized as being 3D. This expands the 3D recognition range without sacrificing the resolution. For example, Japanese Patent Laid-Open No. Hei7-72445 discloses the provision of “a liquid crystal panel (1) for simultaneously displaying a plurality of different parallax images; an optical characteristic variable lens (2) attached to the liquid crystal panel (1) and constructed by an array of cylindrical lenses such that optical characteristics of the cylindrical lenses can be changed; a head detecting section (3) for detecting a spatial position of an observer's head; an optical characteristic variable lens control section (4) connected to the head detecting section (3) and controlling the optical characteristic variable lens (2) based on position information of the head detected at the head detecting section (3) such that a stereoscopic image is regenerated in an optimum position of the observer's head”.

### SUMMARY

As a result of making a study of the two-parallax autostereoscopic display device using eye tracking, the inventors have found the problem in which the brightness is varied depending on the direction of visual angle.

A summary of typical one of the present disclosure will be briefly described below.

More specifically, a 3D display device modulates the brightness of a backlight in accordance with the position of eyes so that the brightness distribution is not varied.

According to the 3D display device described above, it is possible to reduce the variation in brightness which occurs at the time of changing a viewing point.

### BRIEF DESCRIPTION OF THE DRAWINGS

FIG. 1 is a diagram for explaining an overview of a 3D display device.

FIGS. 2A and 2B are schematic diagrams showing a structure of a liquid crystal lens.

FIG. 3 is a cross sectional view of a 3D display element using the liquid crystal lens in FIG. 2A.

FIG. 4 is a diagram showing a result of measurement of the brightness to a viewing angle of the 3D display element in FIG. 3.

FIG. 5 is a schematic cross sectional view showing a structure of an electrode of a dynamic lens.

FIG. 6 is a cross sectional view of a 3D display element using the liquid crystal lens in FIG. 5.

FIG. 7 is a diagram showing the brightness distribution of the 3D display element in FIG. 6.

FIG. 8 is a diagram showing the brightness to a viewing angle at the time of displaying full-white on a display device.

FIG. 9 is an overall view of a 3D display device according to an example.

FIG. 10A is a diagram showing standardized backlight brightness to a viewing angle.

FIG. 10B is a diagram showing standardized brightness distribution of a display device to a viewing angle.

FIG. 11 is an overall view of a 3D display device according to a first variation.

FIG. 12 is an overall view of a 3D display device according to a second variation.

### DESCRIPTION OF THE PREFERRED EMBODIMENTS

Embodiments, examples and variations will be described below using drawings. However, in the description below, like reference numerals will designate the components so as to avoid explaining repeatedly.

<Technology that has been Considered in Advance of the Present Disclosure>

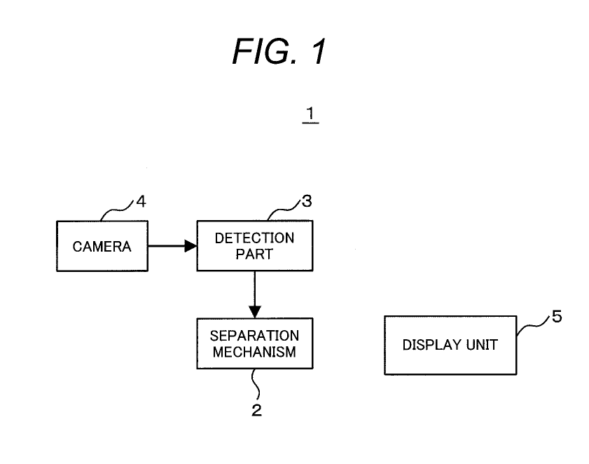

FIG. 1 is a diagram for explaining an overview of a 3D display device. A 3D display device 1 is an autostereoscopic display system using eye tracking (ET). The 3D display device 1 can increase the position where an image can be recognized as being 3D in a two-parallax autostereoscopic display by moving a viewing point. Therefore, the 3D recognition range is expanded without sacrificing resolution.

The 3D display device 1 has a camera 4, and a detection part 3 which determines the position of eyes from an image in the camera 4. The detection part 3 may be integrated into mobile equipment, for example. A display device 5 displays two different parallax images for each cycle. One parallax image is a parallax image corresponding to left eye (a left-eye image), and the other parallax image is a parallax image corresponding to right eye (a right-eye image). A separation mechanism 2 is provided in order to input an image to each of right and left eyes by means of a signal designating the position of eye. The signal output from the detection part 3 is input to the separation mechanism 2, so that it is possible to see a 3D image wherever the position of eyes is if the position of eyes locates within the recognition range of the camera 4.

### (Separation Mechanism)

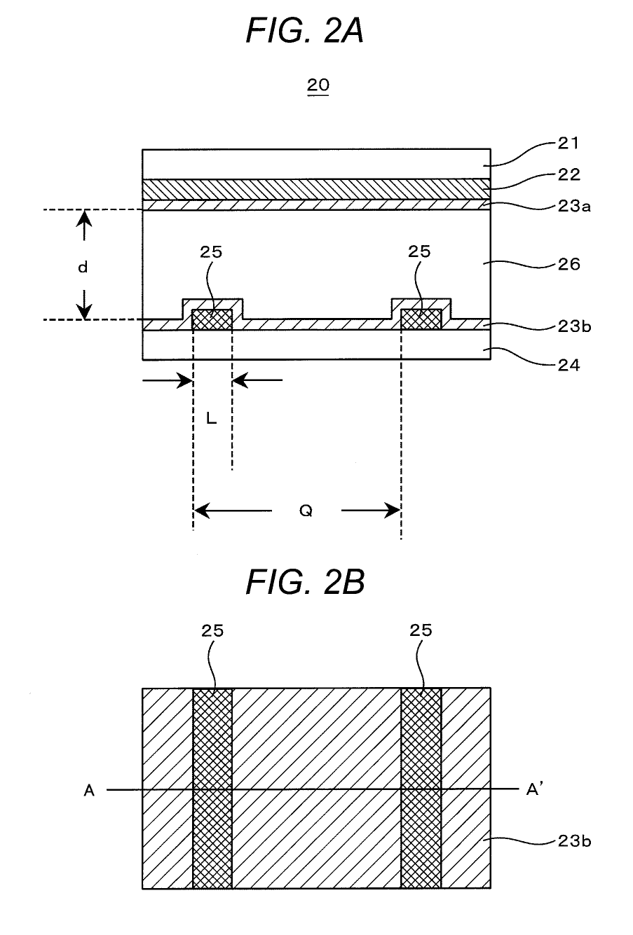

The separation mechanism 2 is composed of a liquid crystal lens. The operation of the liquid crystal lens will be described in detail. FIGS. 2A and 2B are schematic diagrams showing the simplest structure of the liquid crystal lens. FIG. 2A is a cross sectional view which is taken at line A-A′ in FIG. 2B, and FIG. 2B is a plan view (a bottom view). The liquid crystal lens 20 has a first substrate 21, a first electrode 22 attached to the first substrate 21, and an alignment film 23a attached to the first electrode 22. The liquid crystal lens 20 also has a second substrate 24, a second electrode 25 attached to the second substrate 24, and an alignment film 23b attached to the second substrate 24 and the second electrode 25. Furthermore, the liquid crystal lens 20 has a liquid crystal 26 between the alignment film 23a and the alignment film 23b. The liquid crystal lens 20 has a plurality of lenses, and a lens pitch is expressed in Q.

The 4.5-inch diagonal display device 5 with 1280×720 pixels is used here. In the case of the display device 5, Q is about 77 μm. When the width of an electrode is expressed in L and the layer thickness of the liquid crystal 26 is expressed in d, L is about 10 μm and d is on the order of 20 to 30 μm. The first electrode 22 is a transparent electrode which is a plane electrode. The second electrode 25 is a transparent electrode which is comb-like (stripe-shaped within the scope of description in FIG. 2) electrode.

The alignment films 23a and 23b are polyimide, and have a function of horizontal alignment (alignment in parallel to a surface of the substrate). The liquid crystal 26 has positive dielectric constant anisotropy. However, the alignment films 23a and 23b may have a function of vertical alignment, and the liquid crystal 26 may have negative dielectric constant anisotropy. A voltage is applied between the first electrode 22 and the second electrode 25, so that it is possible to switch the state from a non-lens state to a lens state. The applied voltage changes a refractive index of the liquid crystal 26, and thus control of the applied voltage can provide a refraction index distribution. The lens of this kind which can provide a lens effect by the refractive index distribution is referred to as a refractive index dispersion type lens.

### (3D Display Element)

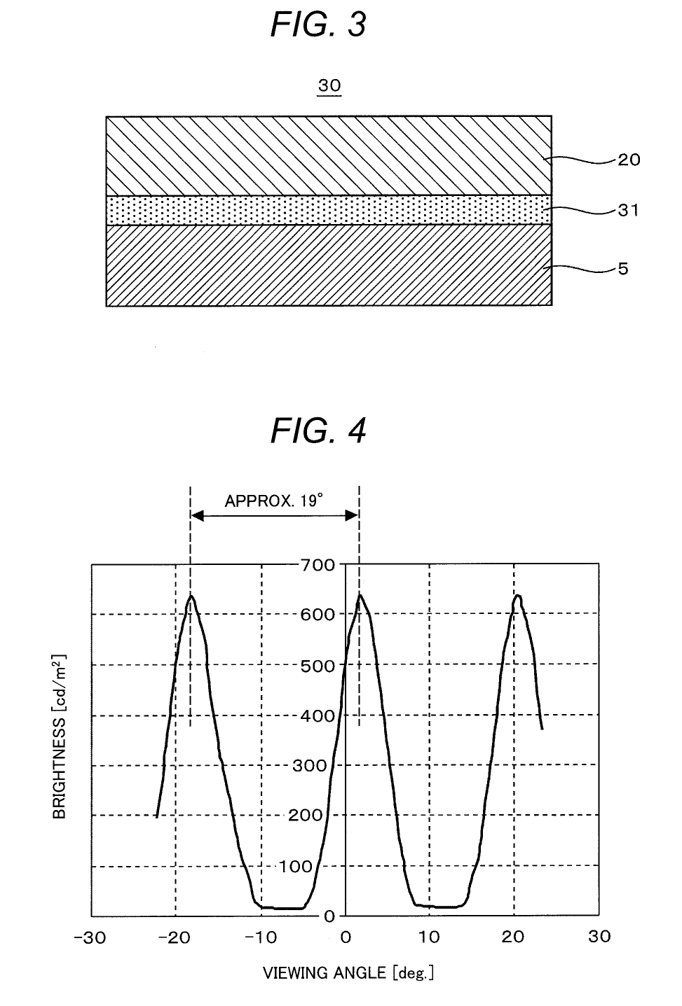

FIG. 3 is a cross sectional view of a 3D display element using the liquid crystal lens in FIG. 2A. FIG. 4 is a diagram showing a result of measurement of brightness to a viewing angle in FIG. 3. A 3D display element 30 is made of the liquid crystal lens 20 bonded to the display device 5 by an adhesive member such as a resin. Measurement has been performed on the brightness to a viewing angle of the 3D display element 30. In this case, a voltage sufficiently above the threshold value is applied to the liquid crystal lens 20 to enter into the 3D display state. The display device 5 displays white for a right-eye picture, and black for a left-eye picture. The viewing angle in FIG. 4 indicates an angle from the direction of the normal to the display device. As can be seen in FIG. 4, the brightness distribution of the 3D display element 30 using the liquid crystal lens 20 has periodicity. The 3D display element 30 is designed so that a 3D image can be seen when a right eye locates at the position where the brightness reaches its peak. More specifically, in the case of brightness distribution shown in FIG. 4, for example, a 3D image can be seen about in 19 periods. The period is determined by the distance between the liquid crystal 26 of the liquid crystal lens 20 and the liquid crystal of the display device 5, the lens pitch between the liquid crystal lens 20, etc.

### (Dynamic Lens)

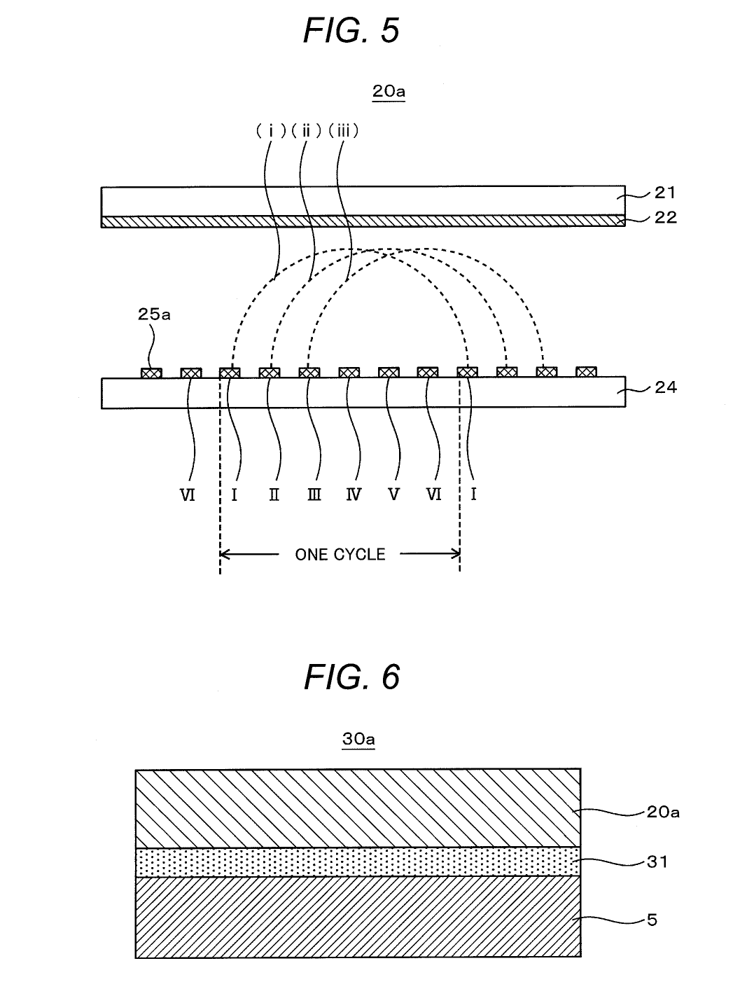

Next, a liquid crystal lens for use in the present disclosure will be described. A liquid crystal lens 20a for use in the present disclosure is different from the liquid crystal lens 20 in FIG. 2 in that a single lens contains a plurality of second electrodes therein. This makes it possible to change only the position of the lens without changing the pitch of the liquid crystal lens. FIG. 5 is a schematic cross sectional view showing the structure of electrode of a dynamic lens. The second electrode 25 shown in FIG. 2 is divided into several pieces. One period is from an electrode I to the next I, and electrodes II to VI are arranged therebetween. While FIG. 5 shows the structure of electrode which can be divided into six, the number of electrode is not particularly limited. The number of divisions is referred to as the number of viewing points. The number of viewing points is the number in which the period shown in FIG. 4 can be divided, for example. More specifically, when divided into six, the range of angle from one viewing point is about 19 degrees/6 divisions=about 3.2 degrees. Since the range of angle in which a 3D image can be seen is on the order of several degrees, a 3D display can be performed in each range of viewing point (3.2 degrees). In the case where a period of angle in which a 3D image can be seen is too wide, increase in the number of viewpoints can be the countermeasure thereto. The lens of this kind in which the position of the lens can be moved is herein referred to as a dynamic lens.

The separation mechanism 2a is composed of the liquid crystal lens 20a. The liquid crystal lens 20a includes a control circuit (not shown) which receives a signal from the detection part 3 to apply a voltage to the electrode 25a. The way of applying a voltage is that, in order to form a lens (i), for example, the highest voltage (such as 6V) is applied to the electrode I out of the electrodes 25a, and then an intermediate voltage (such as 2V) is applied to the electrode II and the electrode VI. Then, the lowest voltage (such as 1V) is applied to the electrode III and the electrode V. Finally, an electrode at the midpoint (the electrode IV) is set to be 0V which is regarded to be the same potential as the first electrode 22 opposite thereto. When the position of the lens is switched (a lens (ii) is formed, for example), the maximum voltage is applied to the electrode II, the intermediate voltage is applied to the electrode I and the electrode III, the minimum voltage is applied to the electrode VI and the electrode IV, and the electrode V is set to be 0V. Applying voltages in this manner makes it possible to move the position of the lens for the number of viewpoints.

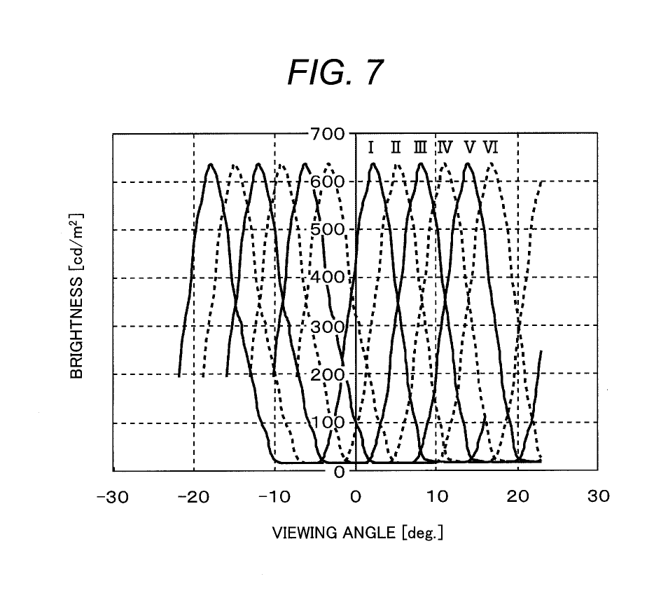

FIG. 6 is a cross sectional view of a 3D display element in FIG. 5. FIG. 7 is a diagram showing a brightness distribution of the 3D display element when the dynamic lens in FIG. 5 is used. A 3D display element 30a is made of the liquid crystal lens 20a bonded to the display device 5 by an adhesive member such as a resin. The display device 5 displays white for a right-eye picture, and black for a left-eye picture. Reference numerals I to VI in FIG. 7 correspond to the electrode I to the electrode VI in FIG. 5 to which the maximum voltage is applied. As can be seen in FIG. 7, it can be found that the position of the brightness distribution changes depending on the position to which the voltage is applied. Eye tracking system carries out the control so that the peak brightness can be obtained at the position of eyes depending on the position of eyes.

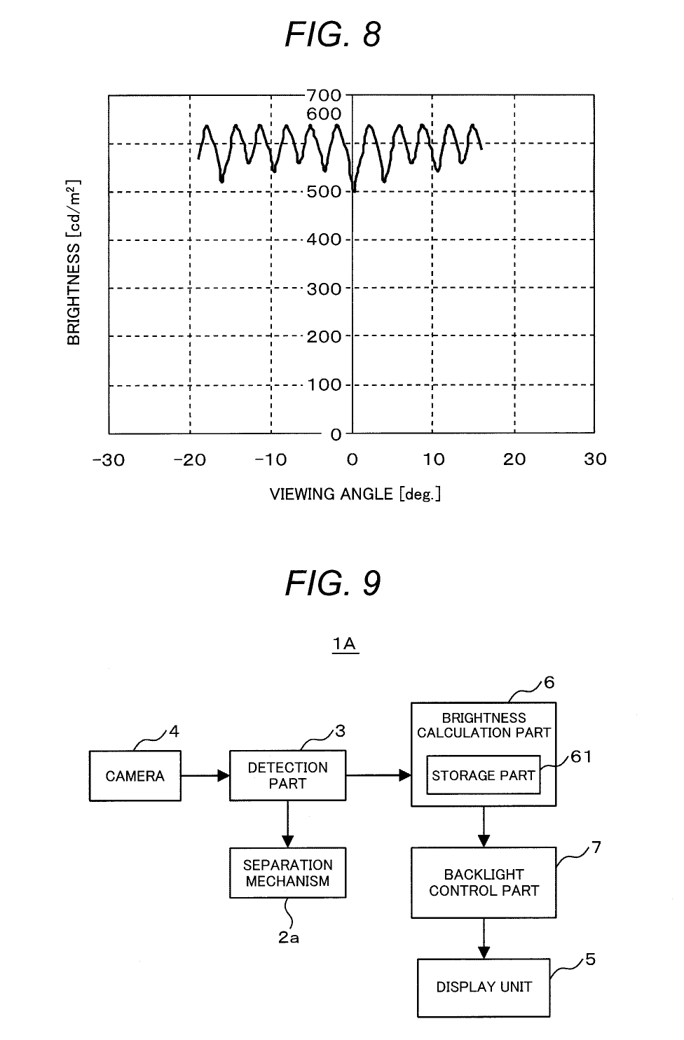

FIG. 8 is a diagram showing the brightness to a viewing angle when the display device displays full-white while operating the eye tracking system. As can be seen in FIG. 8, the problem is that the brightness varies depending on a viewing angle in this manner when a viewpoint is switched by the eye tracking.

Then, a 3D display device (1A) according to the present embodiment is provided with the detection part (3) for recognizing the position of eyes from an image taken by the camera (4), the separation mechanism (2a) which enables a 3D image to be regenerated at the optimum position for eyes based on information on the position of eyes detected by the detection part (3), the display device (5) for displaying a plurality of parallax images at the same time, a backlight attached to the display device (5), and a backlight control part (7) for controlling the backlight, wherein the backlight control part (7) determines brightness of the backlight in accordance with the position of eyes determined by the detection part (3).

The 3D display device according to the embodiment can reduce variation in brightness generated at the time of switching a viewpoint.

As the separation mechanism, it is possible to use a liquid crystal lens as well as a liquid crystal barrier and the like. In the embodiment, an explanation will be made taking a liquid crystal lens as an example. Furthermore, no limitation is imposed on the display device as long as it is a device capable of displaying two-dimensional image. For example, a liquid crystal display device, an organic EL (OLED) device, or a plasma device may be used. In the embodiment, an explanation will be made taking a liquid crystal display device as an example.

### EXAMPLE

FIG. 9 is an overall view of a 3D display device according to an embodiment. A 3D display device 1A is an autostereoscopic display system using eye tracking. The system differs from that shown in FIG. 1 in that the 3D display device 1A has a brightness calculation part 6 and a backlight control part 7 of the display device 5. In addition, the liquid crystal lens (dynamic lens) 20a is used in the separation mechanism 2a according to the example. Therefore, the 3D display element 30a in FIG. 6 is used in the 3D display element according to the example. The display device 5 is provided with a backlight (not shown).

The brightness calculation part 6 is a mechanism for determining the brightness of the backlight in accordance with the position of eyes determined by the detection part 3. The brightness calculation part 6 has a storage part 61 for storing data which is a previously-measured relationship of brightness in accordance with viewing angle as shown in FIG. 8, for example. The brightness calculation part 6 calculates the brightness based on the viewing angle determined by the detection part 3 and the data in the storage part 61, and outputs a signal for adjusting the backlight to the backlight control part 7. The backlight control part 7 is provided with a circuit for executing PWM dimming on a light source of the backlight, and can change brightness level of the light source by changing a frequency or duty of PWM based on a signal for adjusting the backlight. As the light source of the backlight, it is possible to use an LED, an organic EL, an inorganic EL, etc.

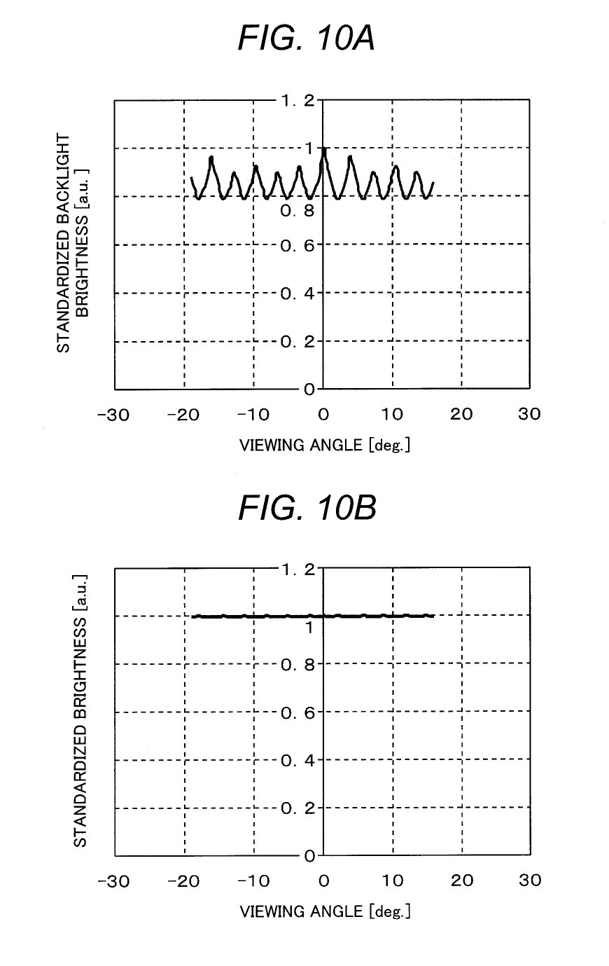

FIG. 10A is a diagram showing standardized backlight brightness to a viewing angle, and FIG. 10B is a diagram showing standardized brightness distribution of a display device to a viewing angle while operating eye tracking system. The display device 5 displays full-white. As can be seen in FIGS. 10A and 10B, it can be found that the 3D display device 1A can reduce variation in brightness by controlling the backlight brightness depending on the viewing angle.

### (First Variation)

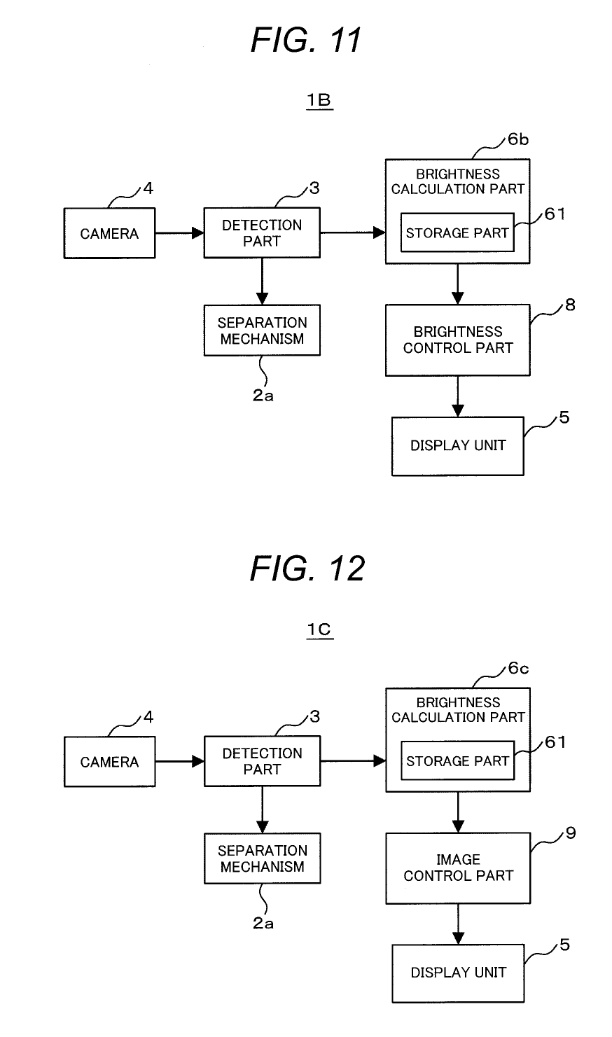

FIG. 11 is an overall view of a 3D display device according to a first variation. The difference from the embodiment is that a 3D display device 1B has a brightness control part 8. A brightness calculation part 6b is a mechanism for determining the brightness in accordance with the position of eyes determined by the detection part 3. The brightness calculation part 6b has a storage part 61 for storing data which is a previously-measured relationship of brightness in accordance with viewing angle as shown in FIG. 8, for example. The brightness calculation part 6b calculates the brightness based on the viewing angle determined by the detection part 3 and the data in the storage part 61, and outputs a signal for adjusting the brightness to the backlight control part 8. The brightness control part 8 controls the brightness so that the brightness does not vary in total in accordance with the viewing angle. The display device 5 may be a liquid crystal display device, an organic EL (OLED) device, a plasma device, etc.

### <Second Variation>

FIG. 12 is an overall view of a 3D display device according to a second variation. The difference from the embodiment is that a 3D display device 1C has an image control part 9. A brightness calculation part 6c is a mechanism for determining the brightness in accordance with the position of eyes determined by the detection part 3. The brightness calculation part 6c has a storage part 61 for storing data which is a previously-measured relationship of brightness in accordance with viewing angle as shown in FIG. 8, for example. The brightness calculation part 6c calculates the brightness based on the viewing angle determined by the detection part 3 and the data in the storage part 61, and outputs a signal for adjusting an image to the image control part 9. The image control part 9 switches the image to be shown up on the display device 5 so that variation in brightness does not become annoying even if the viewing angle changes. The image may have a perceptible brightness level, or may be switched to a multi-view image for 3D display.

While the invention made by the inventors has been specifically described above based on the embodiments, examples and variations, the present invention is not limited to the embodiments, examples and variations described above, but various modifications can be made without mentioning.

What is claimed is:

1. A 3D display device, comprising:
a detection part for recognizing a position of eyes from an image taken by a camera;
a separation mechanism which enables a 3D image to be regenerated at the optimum position for eyes based on information on the position of eyes detected by the detection part;
a display device for displaying a plurality of different parallax images at the same time;
a backlight attached to the display device; and
a backlight control part for controlling the backlight,
wherein the backlight control part determines brightness of the backlight in accordance with the position of eyes determined by the detection part.

2. The 3D display device according to claim 1, further comprising a brightness calculation part,
wherein the brightness calculation part has a storage part for storing data which is a previously-measured relationship of brightness in accordance with viewing angle, and
the brightness calculation part calculates the brightness based on viewing angle determined by the detection part and the data in the storage part, and outputs a signal for adjusting the backlight to the backlight control part.

3. The 3D display device according to claim 2, wherein the separation mechanism is a liquid crystal lens.

4. The 3D display device according to claim 3, wherein the liquid crystal lens is a dynamic lens having a plurality of electrodes in a single lens, the liquid crystal lens moving the position thereof for the number of electrodes by a voltage being applied thereto.

5. The 3D display device according to claim 4, wherein the liquid crystal lens and the display device are bonded to each other by an adhesive member.

6. A 3D display device, comprising:
a detection part for recognizing a position of eyes from an image taken by a camera;
a separation mechanism which enables a 3D image to be regenerated at the optimum position for eyes based on information on the position of eyes detected by the detection part;
a display device for displaying a plurality of different parallax images at the same time; and
a brightness control part for controlling the brightness,
wherein the brightness control part controls the brightness so that the brightness does not vary in total in accordance with the position of eyes determined by the detection part, and in accordance with the viewing angle.

7. The 3D display device according to claim 6, further comprising a brightness calculation part,
wherein the brightness calculation part has a storage part for storing data which is a previously-measured relationship of brightness in accordance with viewing angle, and
the brightness calculation part calculates the brightness based on the viewing angle determined by the detection part and the data in the storage part, and outputs a signal for adjusting the brightness to the brightness control part.

8. The 3D display device according to claim 7, wherein the separation mechanism is a liquid crystal lens.

9. The 3D display device according to claim 8, wherein the liquid crystal lens is a dynamic lens having a plurality of electrodes in a single lens, the liquid crystal lens moving the position thereof for the number of electrodes by a voltage being applied thereto.

10. The 3D display device according to claim 9, wherein the liquid crystal lens and the display device are bonded to each other by an adhesive member.

11. A 3D display device, comprising:
a detection part for recognizing a position of eyes from an image taken by a camera;
a separation mechanism which enables a 3D image to be regenerated at the optimum position for eyes based on information on the position of eyes detected by the detection part;
a display device for displaying a plurality of different parallax images at the same time;
an image control part for controlling an image,
wherein the image control part switches the image to be shown up on the display device in accordance with the position of eyes determined by the detection part so that variation in brightness does not become annoying even if the viewing angle changes.

12. The 3D display device according to claim 11, further comprising a brightness calculation part,
wherein the brightness calculation part has a storage part for storing data which is a previously-measured relationship of brightness in accordance with viewing angle, and
the brightness calculation part calculates the brightness based on the viewing angle determined by the detection part and the data in the storage part, and outputs a signal for adjusting the image to the brightness control part.

13. The 3D display device according to claim 12, wherein the separation mechanism is a liquid crystal lens.

14. The 3D display device according to claim 13, wherein the liquid crystal lens is a dynamic lens having a plurality of electrodes in a single lens, the liquid crystal lens moving the position thereof for the number of electrodes by a voltage being applied thereto.

15. The 3D display device according to claim 14, wherein the liquid crystal lens and the display device are bonded to each other by an adhesive member.
